(19) United States
(12) Patent Application Publication
(10) Pub. No.: US 2025/0274890 A1
(43) Pub. Date: Aug. 28, 2025

(54) NON-COHERENT UPLINK TIMING OFFSET ESTIMATION AND COMPENSATION FOR CSI ESTIMATION AND TRACKING

(71) Applicant: Samsung Electronics Co., Ltd., Suwon-si (KR)

(72) Inventors: Fan Zhang, Plano, TX (US); Yang Li, Plano, TX (US); Vishnu Vardhan Ratnam, Frisco, TX (US)

(21) Appl. No.: 19/009,866

(22) Filed: Jan. 3, 2025

Related U.S. Application Data
(60) Provisional application No. 63/558,974, filed on Feb. 28, 2024.

(51) Int. Cl. H04W 56/00; H04B 7/06; H04L 5/00

(52) U.S. Cl. CPC H04W 56/0045; H04B 7/0626; H04L 5/0051

(57) ABSTRACT

Methods and apparatuses for non-coherent uplink timing offset estimation and compression for channel state information (CSI) estimation and tracking in wireless communication systems. A method includes receiving, from a user equipment (UE), information for an autonomous uplink timing alignment of the UE; estimating, based on the information, a timing offset using a non-coherent maximum likelihood estimator, wherein a plurality of timing offsets associated with a plurality of antennas is combined to estimate the timing offset; compensating for the timing offset based on an adaptive operation using a channel condition; and updating a reference of the non-coherent maximum likelihood estimator based on the compensated timing offset.

### CROSS-REFERENCE TO RELATED APPLICATIONS AND CLAIM OF PRIORITY

The present application claims priority to U.S. Provisional Patent Application No. 63/558,974, filed on Feb. 28, 2024. The contents of the above-identified patent documents are incorporated herein by reference.

### TECHNICAL FIELD

The present disclosure relates generally to wireless communication systems and, more specifically, the present disclosure relates to non-coherent uplink timing offset estimation and compression for channel state information (CSI) estimation and tracking in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to non-coherent uplink timing offset estimation and compression for CSI estimation and tracking in wireless communication systems.

In one embodiment, a base station (BS) in a wireless communication system is provided. The BS comprises a transceiver configured to receive, from a user equipment (UE), information for an autonomous uplink timing alignment of the UE. The BS further comprises a processor operably coupled to the transceiver, the processor configured to: estimate, based on the information, a timing offset using a non-coherent maximum likelihood estimator, wherein a plurality of timing offsets associated with a plurality of antennas is combined to estimate the timing offset, and compensate for the timing offset based on an adaptive operation using a channel condition, and update a reference of the non-coherent maximum likelihood estimator based on the compensated timing offset.

In another embodiment, a method of BS in a wireless communication system is provided. The method comprises: receiving, from a UE, information for an autonomous uplink timing alignment of the UE; estimating, based on the information, a timing offset using a non-coherent maximum likelihood estimator, wherein a plurality of timing offsets associated with a plurality of antennas is combined to estimate the timing offset; compensating for the timing offset based on an adaptive operation using a channel condition; and updating a reference of the non-coherent maximum likelihood estimator based on the compensated timing offset.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate example of wireless transmit and receive paths according to various embodiments of the present disclosure;

FIG. 6 illustrates an example of antenna structure according to various embodiments of the present disclosure;

FIG. 7A illustrates a flowchart of a method for performing timing offset estimation and compensation for channel prediction according to various embodiments of the present disclosure;

FIG. 7B illustrates a flowchart of a method 700 for performing timing offset estimation and compensation for channel estimation according to various embodiments of the present disclosure;

FIG. 8 illustrates a flowchart of a method for performing timing offset estimation and compensation process according to various embodiments of the present disclosure;

FIG. 9 illustrates a flowchart of a method for performing frequency offset estimation and compensation process according to various embodiments of the present disclosure;

FIG. 10 illustrates a flowchart of a method for performing frequency offset estimation and compensation process according to various embodiments of the present disclosure;

FIG. 11 illustrates a flowchart of a method for performing timing estimation and timing compensation process according to various embodiments of the present disclosure;

FIG. 12 illustrates an example of SRS buffer according to various embodiments of the present disclosure;

FIG. 13 illustrates an example of SRS buffer according to various embodiments of the present disclosure; and

FIG. 14 illustrates a flowchart of a method for non-coherent uplink timing offset estimation and compression for CSI estimation and tracking according to various embodiments of the present disclosure.

### DETAILED DESCRIPTION

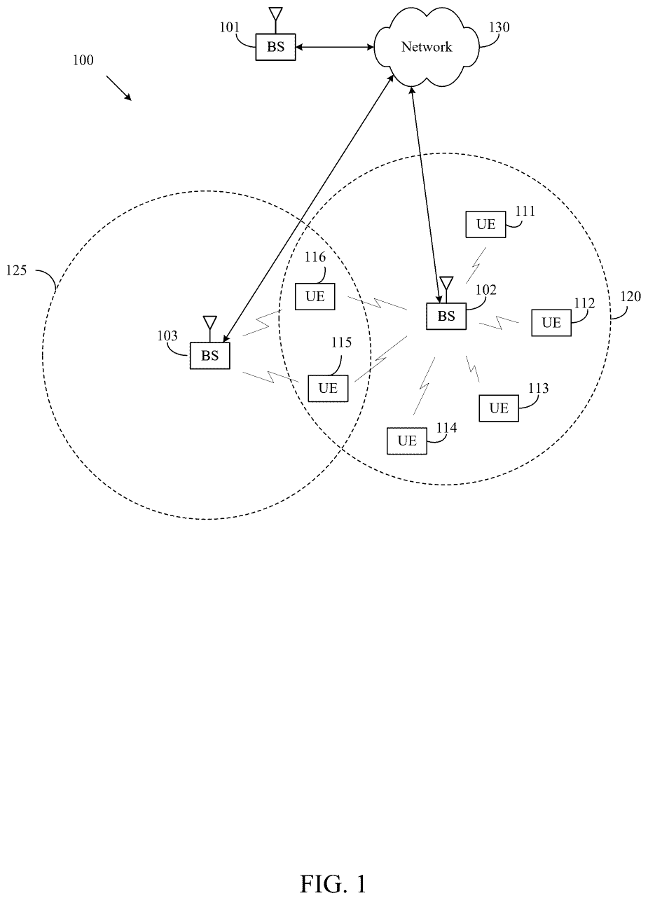

FIG. 1 through FIG. 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in the present disclosure to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in the present disclosure to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the gNBs 101-103 includes circuitry, programing, or a combination thereof, to support non-coherent uplink timing offset estimation and compression for CSI estimation and tracking in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

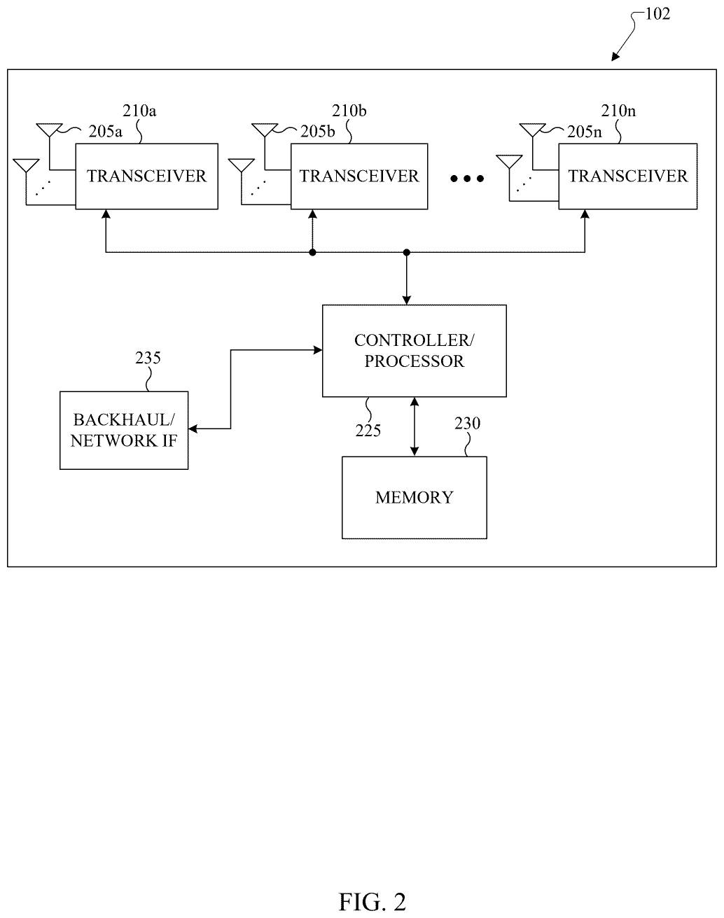

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support non-coherent uplink timing offset estimation and compression for CSI estimation and tracking in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

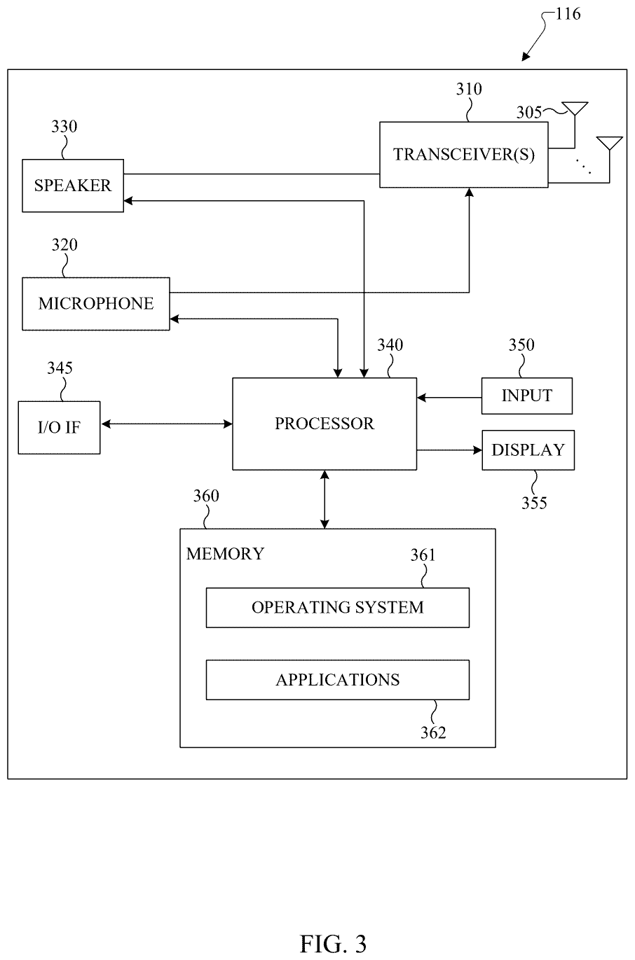

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

In various embodiments, the processor 340 may execute processes to perform non-coherent uplink timing offset estimation and compression for CSI estimation and tracking in wireless communication systems as described in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

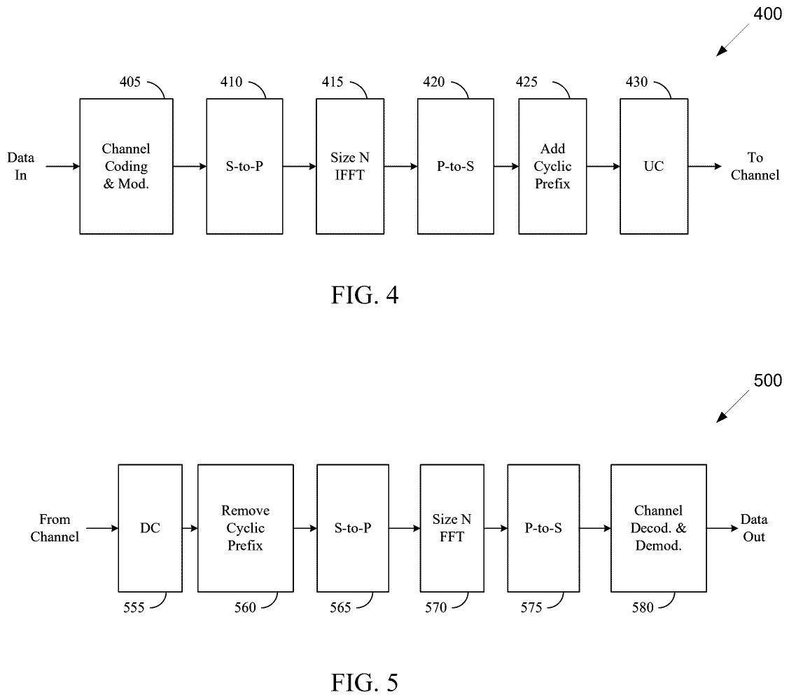

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

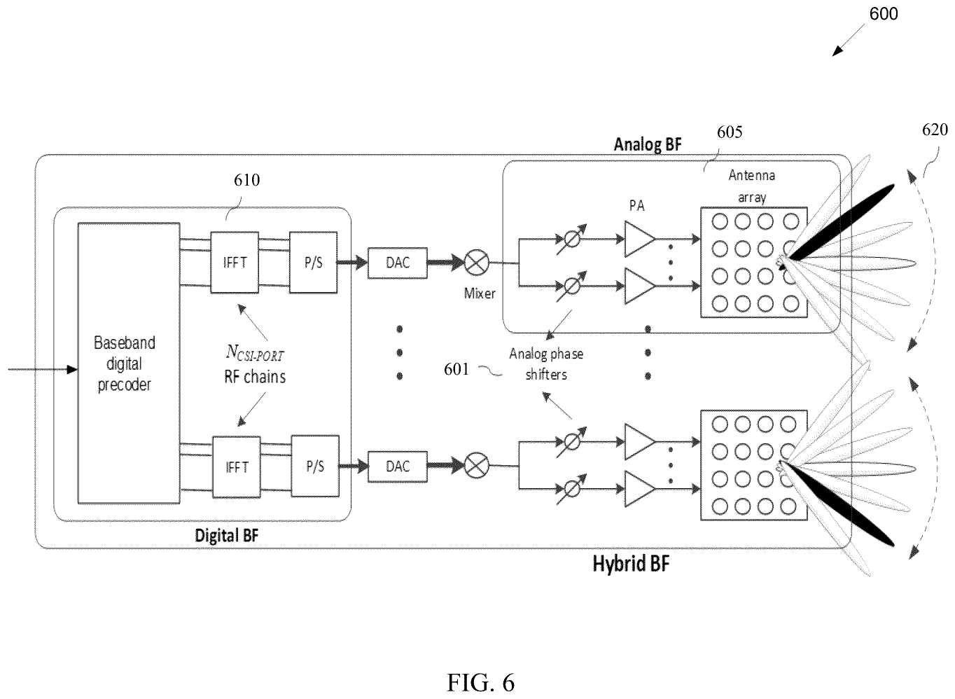

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

MIMO technologies have a key role in boosting system throughput both in NR and LTE and such a role may continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Massive MIMO (mMIMO) is an important technology to improve the spectral efficiency of 4G and 5G cellular networks, and it has been adopted in Samsung massive MIMO unit (MMU). The number of antennas in mMIMO is typically much larger than the number of user equipment (UE), which allows BS to perform multi-user downlink (DL) beamforming to schedule parallel data transmission on the same time-frequency resources. However, its performance depends heavily on the quality of channel state information (CSI) at BS. It has been recently verified that the MU-MIMO performance degrades with UE mobility. The present disclosure provides solutions for the BS to track channel parameters used for CSI estimation.

The channel state information is quickly out-of-date for mMIMO BS which relies on sounding reference signal (SRS) sent by UE in the network. This greatly reduce the performance of mMIMO DL MU-MIMO transmission with mobile UEs. In addition, the received SRS is corrupted with UE's autonomous timing alignment efforts.

The present disclosure provides a new timing offset estimation/correction method that is caused by UE's autonomous uplink timing alignment efforts. The estimation and correction method uses non-coherent maximum likelihood estimator for timing offset estimation, combining offsets over multiple antennas and compensated. The reference of the non-coherent ML estimator is updated with timing correction and adaptive algorithm.

In one embodiment, the present disclosure provides timing offset estimation and correction based on a UE's autonomous uplink timing alignment.

In one embodiment, the present disclosure provides a non-coherent maximum likelihood estimator for the timing offset estimation and correction, wherein multiple time offsets are combined over multiple antennas and compensated.

In one embodiment, the present disclosure provides an update of a reference of the non-coherent maximum likelihood estimator based on a timing correction and an adaptive algorithm.

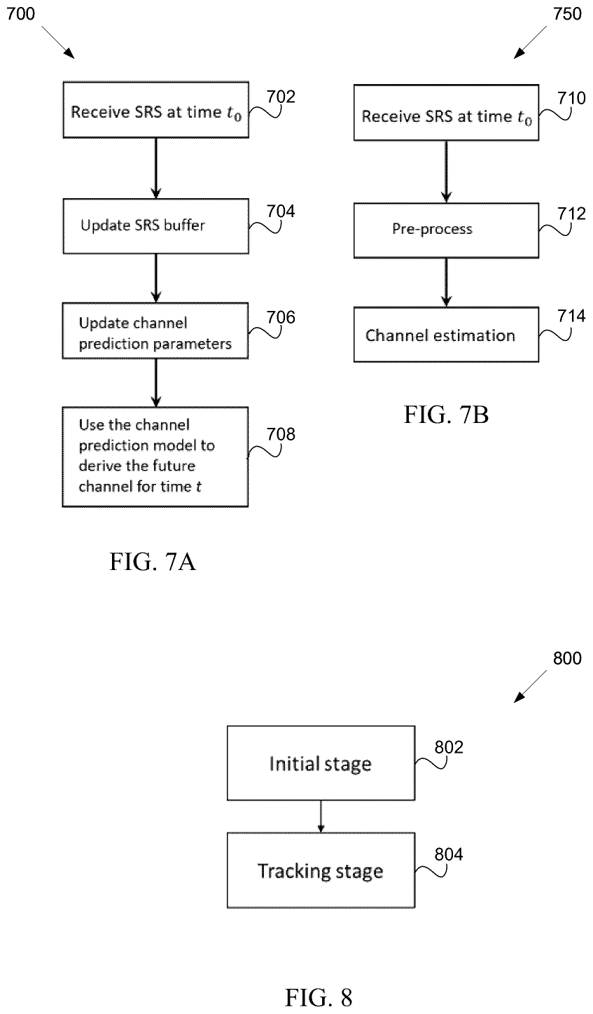

FIG. 7A illustrates a flowchart of a method 700 for performing timing offset estimation and compensation for channel prediction according to various embodiments of the present disclosure. The method 700 as may be performed by a BS (e.g., 101-103 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

The present disclosure provides timing offset estimation and compensation and channel estimation in FIG. 7A. Uplink timing and frequency offsets are unavoidable effect that are caused by UEs. A random timing offset in the present disclosure refers to the sample-wise UL timing adjustment performed by a UE at random time instances depending on UE's own assessment of its time drift to eNB/gNB.

As illustrated in FIG. 7A, in step 702, a BS receives a sounding reference signal (SRS) at time tₒ. In step 704, the BS updates the SRS buffer. Subsequently, in step 706, the BS updates the channel prediction parameters. Finally, the BS uses the channel prediction model to derive the future channel for time t.

FIG. 7B illustrates a flowchart of a method 750 for performing timing offset estimation and compensation for channel estimation according to various embodiments of the present disclosure. The method 750 as may be performed by a BS (e.g., 101-103 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7B, in step 710, a BS receives a sounding reference signal (SRS) at time to. In step 712, the BS performs the pre-process, Finally, the BS performs the channel estimation.

FIG. 8 illustrates a flowchart of a method 800 for performing timing offset estimation and compensation process according to various embodiments of the present disclosure. The method 800 as may be performed by a BS (e.g., 101-103 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

The timing offset estimation and compensation process can be implemented two sequential stages as illustrated in FIG. 8, step 802 and step 804. The initial stage 802 is performed once at the beginning, and then the tracking stages 804 is iteratively performed. In the present disclosure, the number of SRS instances are generally more than one which requires both the initial and the tracking stages. In cases where the received SRS does not satisfy requirements (e.g., low received SNR/power), operation 804 may be skipped.

In one embodiment, timing offset (TO) and frequency offset (FO) estimation and compensation (FO estimation/compensation is not included in the present disclosure) are provided. Such embodiment is illustrated in FIG. 10. In some embodiments, the order of four operations (e.g., 902, 904, 906, and 908) may change.

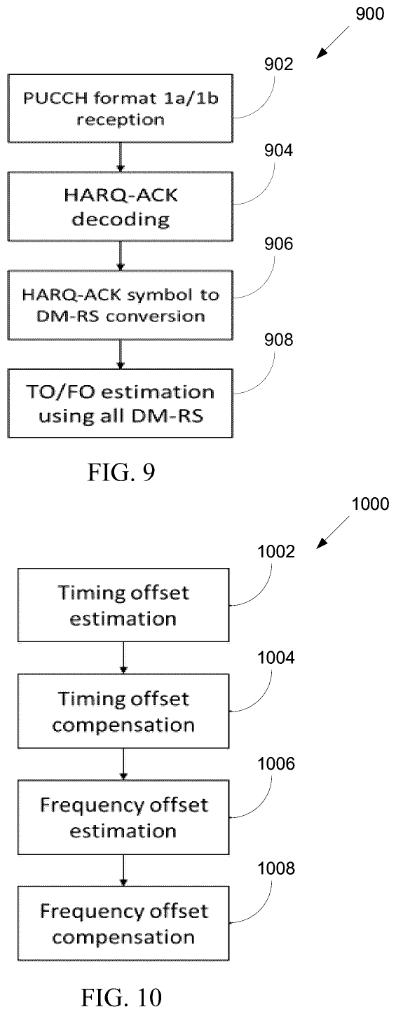

FIG. 9 illustrates a flowchart of a method 900 for performing frequency offset estimation and compensation process according to various embodiments of the present disclosure. The method 900 as may be performed by a BS (e.g., 101-103 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

TO can be estimated using different resources. In one embodiment, PUCCH is used. For this purposes, DM-RS of PUCCH with format 1a/1b or 3 is used. When a UE is configured for periodic CSI reporting, format 2 can also be used. In case of PUCCH format 1a/1b, HARQ-ACK symbol can also be used as if they are DM-RS for TO estimation once a decision on ACK/NACK value is made. Then, the 1^{st}/2^{nd}/3^{rd} symbols can be correlated with 5^{th}/6^{th}/7^{th} symbols in each slot or symbols in different subframes can also be correlated for TO estimation. Refer to FIG. 9 for the specific procedure to PUCCH format 1a/1b.

As illustrated in FIG. 9, a BS receives a PUCCH format 1a/1b in step 902. Subsequently, in step 904, the BS decodes the HARQ-ACK. Next, the BS convert the HARQ-ACK symbol to DM-RS. Finally, the BS in step 908 estimate the TO and FO using all DM-Rs.

FIG. 10 illustrates a flowchart of a method 1000 for performing frequency offset estimation and compensation process according to various embodiments of the present disclosure. The method 1000 as may be performed by a BS (e.g., 101-103 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, the BS estimates the timing offset in step 1002. In step 1004, the BS compensates the timing offset. In step 1006, the BS estimates the frequency offset. And finally, the BS in step 1008, compensate the frequency offset.

In another embodiment, PUSCH is used. For example, DM-RS of PUSCH can be used for TO and FO estimation. In another embodiment, PT-RS in 5G NR is used. Henceforth, TO are estimated using SRS. Nevertheless, the algorithms described in the present disclosure are not limited to SRS and can use other resources described earlier at least in some part of the algorithms.

In the initial stage (e.g., operation 802): receive the first SRS, the initial reference covariance matrix is initialized. There is no timing/frequency offset correction. Denote yₖ: M dimension vector as the SRS channel estimate at antenna k(1≤k≤K), M is the number of RBs, C_{ref}: M×M as the reference covariance matrix with dimension of number of RBs, C_{ref} (m₁, m₂) represents the element at column m₁ and row m₂.

In one embodiment, a reference covariance matrix initialization is performed. The reference covariance matrix C_{ref} is initialized as follows:

$${C}_{ref} = \frac{1}{K} {\sum }_{1 \leq k \leq K} {{y}_{K} ( {y}_{k} )}^{H} .$$

In another embodiment, the initialization of reference covariance matrix can be estimated by the weighted sum of the product over different antennas, the weight αₖ≥0 can be determined by the antenna power (including normalization), antenna failure and other factors:

$${C}_{ref} = \frac{1}{{\sum }_{k} {α}_{k}} {\sum }_{1 \leq k \leq K} {α}_{k} {{y}_{K} ( {y}_{k} )}^{H} .$$

In the tracking stage (e.g., operation 804). Timing offset estimation and compensation may remove the random timing offsets that corrupt channel path delay estimates.

In one embodiment, the timing offset detection is provided. In such embodiment, the timing offset jump is estimated by employing the hypothesis testing. It first rotates a reference covariance matrix by a timing offset hypothesis, then computes the probability density function of the new SRS conditioned on the rotated covariance matrix. This process is iterated for a set of timing offset hypotheses, and the timing offset that achieves the highest probability density is used for compensation.

Denote yₖ as the most recent SRS channel estimate at antenna k (1≤k≤K), y_{k,m} as the corresponding channel estimate at RB m and T_{HT}={Δτ₁, Δτ₂ . . . , Δτ_{L}} as a set of timing offsets for hypothesis testing. The hypothesis testing set can be designed to cover the whole detectable delay range or based on some prior knowledge of the timing offset behavior. The probability density function of antenna k with covariance matrix C is modeled with gaussian distribution, with the assumption each antenna shares the same covariance matrix:

$$p ( {y}_{k} \vert C ) = \frac{1}{{π}^{M} \vert det ( C ) \vert} {e}^{- {y}_{k}^{H} {C}^{- 1} {y}_{k}} .$$

Denote the rotated covariance matrix of C_{ref} with timing offset Δτ as C_{Δτ}. The rotation operation of the covariance matrix follows the below equation: C_{Δτ}(m₁, m₂)=C_{ref}(m₁, m₂)e^{-j2π(m}^{₁}^{-m}^{₂}^{)Δf}^{_{RB}}^{Δτ}, for 1 m₁, m₂ M.

With maximum likelihood estimator (MLE), exclusive search for the optimal timing offset Δτₑₛₜ in hypothesis testing set T_{HT}, maximizing the probability density function P(yₖ|C(A)). Because |det(C(Δτ))| does not depend on Δτ, considering the multiple antenna input, the MLE is equivalent to minimize the sum over all the metric: exponential quadratic term over antennas: Δτₑₛₜ=argmin_{Δτ∈T}_{_{HT}}Σ_{1≤k≤K}yₖ^{H}C(Δτ)⁻¹yₖ.

In one embodiment, the quadratic metric y^{H}C⁻¹y are directly added up (above equation). In other embodiments, the metric can be added up with some scaling factor η_{K}: Δτₑₛₜ-argmin_{Δτ∈T}_{_{HT}}Σ_{1≤k≤K}ηₖyₖ^{H}C(Δτ)⁻¹yₖ.

The scaling factor ηₖ≥0 can be calculated considering different factors, such as power, stability, antenna failure etc. over different antennas.

In another embodiment, when calculating the matrix inversion C(Δτ)⁻¹, to process ill-conditioned matrix inversion, the matrix is first added with some regularization term. It is calculated multiplying the regularization factor β with the average value of the trace of the matrix, and identity matrix: C_{reg}=β·mean(trace(C(Δτ)))·I.

In such embodiment, the MLE for detected timing offset is then changed with the regularized matrix inversion: Δτₑₛₜ=argmin_{Δτ∈T}_{_{HT}}Σ_{1≤k≤K}αₖyₖ^{H}(C(Δτ)+C_{reg})⁻¹yₖ.

In one embodiment, a reference covariance matrix update/timing offset correction is provided. In such embodiment, the timing offset correction and reference covariance update can be achieved in two different ways. In one embodiment, the timing offset correction is applied in stored channel estimates in the buffer. In another embodiment, the timing offset correction is applied in the latest incoming SRS. In such embodiments, the reference covariance matrix C_{ref} is updated after the timing offset correction and include different update methods in these two embodiments.

In one embodiment, the timing offset correction is applied to the buffer, which has size N_{SRS}, it follows the below operation, where n is the SRS index in the buffer: y_{k,m}(n)←y_{k,m}(n) e^{-j2πmΔf}^{_{RB}}^{Δτ}^{ₑₛₜ}, ∀k, m, and 2≤n≤Nₛᵣₛ.

The SRS index starts from 2 because the correction does not include the oldest SRS (n=1), which may be discarded after inserting the latest SRS into the buffer. In such embodiment, the covariance for reference is first corrected according to the detected timing offset Δτₑₛₜ, following the below equation:

$${C}_{{Δτ}_{est}} ( {m}_{1} , {m}_{2} ) = {C}_{ref} ( {m}_{1} , {m}_{2} ) {e}^{j 2 π ( {m}_{1} - {m}_{2} ) Δ f {Δτ}_{est}} ,$$

Then it is updated with the uncorrected incoming SRS with IIR filter, where A is the forgetting factor. The forgetting factor can be adjusted according to the channel condition; it also can be a fixed value or dynamically change over time:

$${C}_{ref} ← λ {C}_{{Δτ}_{est}} + \frac{( 1 - λ )}{K} {\sum }_{1 \leq k \leq K} {y}_{k} {y}_{k}^{H} .$$

In another embodiment, the timing offset is corrected with the latest incoming SRS.

The lasted SRS is corrected following the below operation

$${y}_{k , m} ← {y}_{k , m} {e}^{j 2 π m Δ f {Δτ}_{est}} ,$$

∀k,m.

In such embodiment, there is no correction step for the reference covariance matrix. The timing offset corrected incoming SRS y′_{k,m} is used for updating the reference covariance

$${C}_{ref} ← λ {C}_{ref} + \frac{( 1 - λ )}{K} {\sum }_{1 \leq k \leq K} {{y}_{k} ( {y}_{k} )}^{H} .$$

For FO estimation and compensation (e.g., operation 906, 908), in one embodiment, when FO estimation/compensation is performed after TO estimation/compensation, the output of timing estimation and compensation Δτₑₛₜ from the present disclosure can be used in some frequency offset estimation/compensation operations.

In one example, timing and frequency offset differences are removed in multiple UL SRS.

In one example, method uses SRS history such as channel prediction.

In one example, system performance does not degrade with random TO in SRS in median speed (15-20 kmph): (1) use MIMO throughput with mobile UEs w/o TO injection and channel prediction on as reference; (2) throughput degradation is small with random TO injected in UL; (3) if having access to the input/output of the timing offset module: (i) generate channel according to the same distribution but independent over time and (ii) inject random timing-offset, the output estimated is accurate.

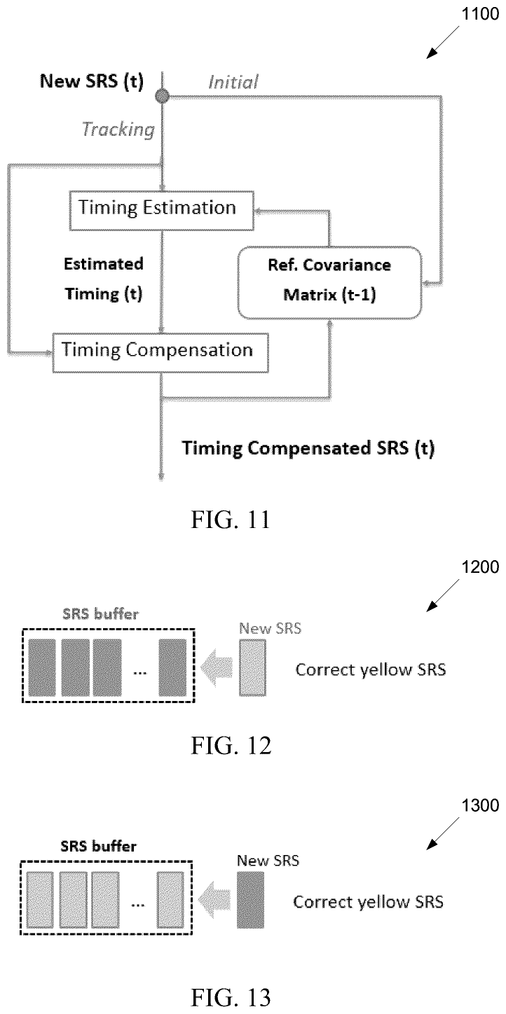

FIG. 11 illustrates a flowchart of a method 1100 for performing timing estimation and timing compensation process according to various embodiments of the present disclosure. The method 1100 as may be performed by a BS (e.g., 101-103 as illustrated in FIG. 1). An embodiment of the method 1000 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, a method includes two states such as an initial stage and a tracking stage.

In one example, non-coherent estimation is provided. In such embodiment, the reference used for timing estimation is 2^{nd} order statistics calculated from all previous samples, no observation/prediction for current time.

In one example, an update on reference is provided. In such embodiment, signal is compensated for updating reference aims at adapting the channel evolvement over time.

In one example, comparison with commercialized solution in channel prediction (use predicted SRS(t) as reference) is provided (e.g., no requirement of other modules and it does not depend on other module's quality).

In the initial stage as illustrated in FIG. 11, an input is provided: new SRS yₖ E C^{M}, K antennas, M frequency response. The 1^{st} reference covariance matrix is generated:

$${C}_{ref} = \frac{1}{K} {\sum }_{1 \leq k \leq K} {{y}_{K} ( {y}_{k} )}^{H} .$$

Initialize the hypothesis timing offset (e.g., which is from current NR commercial system): T_{HT}={Δτ₁, Δτ₂ . . . , Δτ_{L}}={−326:2: −194, −66: 2:66, 194: 2:326}[nano second].

In one embodiment, followings can be inputs: (1) new SRS yₖ ∈C^{M}, K antennas, M frequency response; (2) Reference matrix: C_{ref} ∈C^{M×M}; and (3) hypothesis timing set: T_{HT}. Covariance matrix C_{Δτ} is generated with the hypothesis timing set and reference matrix: C_{Δτ}(m₁, m₂)=C_{ref}(m₁, m₂)e^{-j2π(m}^{₁}^{-m}^{₂}^{)ΔfΔτ}, 1<m₁, m₂≤M.

In one embodiment, timing offset estimation is provided by hypothesis testing calculating maximum likelihood: Δτₑₛₜ=argmin_{Δτ∈T}_{_{HT}}Σ_{1≤k≤K}yₖ^{H}C_{Δτ}⁻¹yₖ.

In one embodiment, a probability distribution function giving covariance (C_{ref}: nRB×nRB) with rotation Δτ is provided:

$$p ( y \vert {C}_{ref} ( Δτ ) ) = \frac{1}{{π}^{N} \vert det ( {C}_{ref} ) \vert} {e}^{- {y}^{H} {C}_{ref}^{- 1} ( Δτ ) y} .$$

In one embodiment, a maximum likelihood detection is provided for Δτ: Δτₑₛₜ=argmax_{Δτ}p(y^{new}|C_{ref}(Δτ))=argmin_{Δτ}[(y^{new})^{H}C_{ref}⁻¹(Δτ)yₖ^{new}].

In one example, for multiple-antennas [assume each antenna has the same covariance over RBs], following for Δτ is provided: Δτₑₛₜ=argmaxΔτΠₖpₖ(yₖ^{new}|C_{ref}(Δτ))=argminΔτΣₖ[(yₖ^{new})^{H}C_{ref}⁻¹(Δτ)yₖ^{new}].

In one embodiment, current input SRS may be corrected. In such embodiment, a timing compensation with estimated Δτₑₛₜ is provided:

$${y}_{k , m} ← {y}_{k , m} {e}^{j 2 π m Δ f {Δτ}_{est}} ,$$

∀k,m. In such embodiment, an update reference covariance matrix with the timing compensated SRS is provided: λ is the forgetting factor, chosen according to channel profile and

$${C}_{ref} ← λ {C}_{{Δτ}_{est}} + \frac{( 1 - λ )}{K} {\sum }_{1 \leq k \leq K} {y}_{k} {y}_{k}^{H} .$$

FIG. 12 illustrates an example of SRS buffer according to various embodiments of the present disclosure. An embodiment of the SRS buffer shown in FIG. 12 is for illustration only.

As illustrated in FIG. 12, when a BS receives as SRS at time tₒ, the BS may update the SRS buffer with a new SRS and the BS may updates the channel prediction parameters based on the current SRS without the SRS stored in the SRS buffer.

In one embodiment, previous SRS is corrected. In such embodiment, a timing compensation is provided on SRS history: y_{k,m}(n)←y_{k,m}(n)·e^{-j2πmΔfΔτest}, 2≤n≤Nₛᵣₛ, ∀k, m. In such embodiment, a timing compensation is provided on reference covariance:

$${C}_{{Δτ}_{est}} ( {m}_{1} , {m}_{2} ) ← {C}_{ref} ( {m}_{1} , {m}_{2} ) {e}^{j 2 π ( {m}_{1} - {m}_{2} ) Δ f {Δτ}_{est}} .$$

In such embodiment, reference covariance matrix is updated:

$${C}_{ref} ← λ {C}_{{Δτ}_{est}} + \frac{( 1 - λ )}{K} {\sum }_{1 \leq k \leq K} {y}_{k} {y}_{k}^{H} .$$

FIG. 13 illustrates an example of SRS buffer according to various embodiments of the present disclosure. An embodiment of the SRS buffer shown in FIG. 13 is for illustration only.

As illustrated in FIG. 13, when a BS receives as SRS at time to, the BS may update the channel prediction parameters based on the stored SRS in the SRS buffer without the current SRS received at the time to. The BS may update the SRS buffer with a new SRS for further channel estimation to generate the channel prediction parameters.

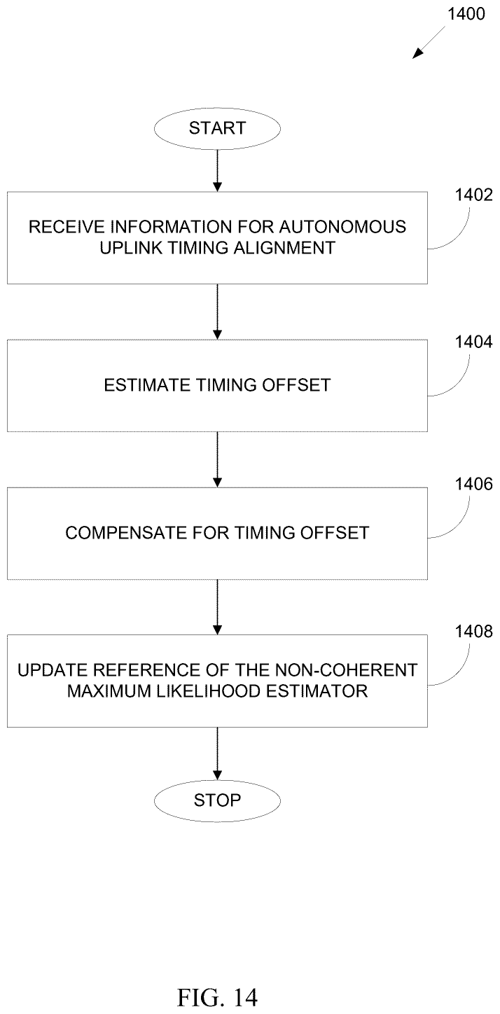

FIG. 14 illustrates a flowchart of a method 1400 for non-coherent uplink timing offset estimation and compression for CSI estimation and tracking according to various embodiments of the present disclosure. The method 1400 as may be performed by a base station (e.g., 101-103 as illustrated in FIG. 1). An embodiment of the method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, in step 1402, a BS receives, from a UE, information for an autonomous uplink timing alignment of the UE.

Subsequently, in step 1404, the BS estimates, based on the information, a timing offset using a non-coherent maximum likelihood estimator, wherein a plurality of timing offsets associated with a plurality of antennas is combined to estimate the timing offset.

Next, in step 1406, the BS compensates for the timing offset based on an adaptive operation using a channel condition.

Finally, in step 1408, the BS updates a reference of the non-coherent maximum likelihood estimator based on the compensated timing offset. In step 1408, the reference of the non-coherent maximum likelihood estimator is identified as a second order statistics calculated based on history information associated with the timing offset estimated and compensated.

In one embodiment, the BS identifies an SRS associated with the plurality of antennas and frequency responses, generates, based on the SRS, a reference covariance matrix, and initializes, based on the reference covariance matrix, a hypothesis timing offset to estimate the timing offset.

In one embodiment, the BS identifies an SRS associated with the plurality of antennas and frequency responses, a reference covariance matrix, and a hypothesis timing offset, and generates, based on the reference covariance matrix and the hypothesis timing offset, a covariance matrix.

In one embodiment, the BS performs a hypothesis testing operation to calculate a maximum likelihood value for the non-coherent maximum likelihood estimator.

In one embodiment, the BS calculates a probability function for a reference covariance matrix using a rotation of the timing offset.

In one embodiment, the BS identifies a current SRS for compensating the timing offset and identify, based on the compensated timing offset using the current SRS, a forgetting factor for updating the reference of the non-coherent maximum likelihood estimator in accordance with a channel profile.

In one embodiment, the BS stores the current SRS into an SRS buffer and compensates the timing offset for the current SRS excluding SRSs stored in the SRS buffer.

In one embodiment, the BS identifies history information of previous SRSs for compensating the timing offset and identify, based on the compensated timing offset using the previous SRSs, a forgetting factor for updating the reference of the non-coherent maximum likelihood estimator in accordance with a channel profile.

In one embodiment, the BS compensates the timing offset for SRSs stored in an SRS buffer excluding a current SRS and stores the current SRS into the SRS buffer.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive, from a user equipment (UE), information for an autonomous uplink timing alignment of the UE; and
a processor operably coupled to the transceiver, the processor configured to:
estimate, based on the information, a timing offset using a non-coherent maximum likelihood estimator, wherein a plurality of timing offsets associated with a plurality of antennas is combined to estimate the timing offset, and
compensate for the timing offset based on an adaptive operation using a channel condition, and
update a reference of the non-coherent maximum likelihood estimator based on the compensated timing offset.

2. The BS of claim 1, wherein the reference of the non-coherent maximum likelihood estimator is identified as a second order statistics calculated based on history information associated with the timing offset estimated and compensated.

3. The BS of claim 1, wherein the processor is further configured to:
identify a sounding reference signal (SRS) associated with the plurality of antennas and frequency responses;
generate, based on the SRS, a reference covariance matrix; and
initialize, based on the reference covariance matrix, a hypothesis timing offset to estimate the timing offset.

4. The BS of claim 1, wherein the processor is further configured to:
identify a sounding reference signal (SRS) associated with the plurality of antennas and frequency responses, a reference covariance matrix, and a hypothesis timing offset; and
generate, based on the reference covariance matrix and the hypothesis timing offset, a covariance matrix.

5. The BS of claim 1, wherein the processor is further configured to perform a hypothesis testing operation to calculate a maximum likelihood value for the non-coherent maximum likelihood estimator.

6. The BS of claim 1, wherein the processor is further configured to calculate a probability function for a reference covariance matrix using a rotation of the timing offset.

7. The BS of claim 1, wherein the processor is further configured to:
identify a current sounding reference signal (SRS) for compensating the timing offset; and
identify, based on the compensated timing offset using the current SRS, a forgetting factor for updating the reference of the non-coherent maximum likelihood estimator in accordance with a channel profile.

8. The BS of claim 7, wherein the processor is further configured to:
store the current SRS into an SRS buffer; and
compensate the timing offset for the current SRS excluding SRSs stored in the SRS buffer.

9. The BS of claim 1, wherein the processor is further configured to:
identify history information of previous sounding reference signals (SRSs) for compensating the timing offset; and
identify, based on the compensated timing offset using the previous SRSs, a forgetting factor for updating the reference of the non-coherent maximum likelihood estimator in accordance with a channel profile.

10. The BS of claim 9, wherein the processor is further configured to:
compensate the timing offset for SRSs stored in an SRS buffer excluding a current SRS; and
store the current SRS into the SRS buffer.

11. A method of base station (BS) in a wireless communication system, the method comprising:
receiving, from a user equipment (UE), information for an autonomous uplink timing alignment of the UE;
estimating, based on the information, a timing offset using a non-coherent maximum likelihood estimator, wherein a plurality of timing offsets associated with a plurality of antennas is combined to estimate the timing offset;
compensating for the timing offset based on an adaptive operation using a channel condition; and
updating a reference of the non-coherent maximum likelihood estimator based on the compensated timing offset.

12. The method of claim 11, wherein the reference of the non-coherent maximum likelihood estimator is identified as a second order statistics calculated based on history information associated with the timing offset estimated and compensated.

13. The method of claim 11, further comprising:
identifying a sounding reference signal (SRS) associated with the plurality of antennas and frequency responses;
generating, based on the SRS, a reference covariance matrix; and
initializing, based on the reference covariance matrix, a hypothesis timing offset to estimate the timing offset.

14. The method of claim 11, further comprising:
identifying a sounding reference signal (SRS) associated with the plurality of antennas and frequency responses, a reference covariance matrix, and a hypothesis timing offset; and
generating, based on the reference covariance matrix and the hypothesis timing offset, a covariance matrix.

15. The method of claim 11, further comprising performing a hypothesis testing operation to calculate a maximum likelihood value for the non-coherent maximum likelihood estimator.

16. The method of claim 11, further comprising calculating a probability function for a reference covariance matrix using a rotation of the timing offset.

17. The method of claim 11, further comprising:
identifying a current sounding reference signal (SRS) for compensating the timing offset; and
identifying, based on the compensated timing offset using the current SRS, a forgetting factor for updating the reference of the non-coherent maximum likelihood estimator in accordance with a channel profile.

18. The method of claim 17, further comprising:
storing the current SRS into an SRS buffer; and
compensating the timing offset for the current SRS excluding SRSs stored in the SRS buffer.

19. The method of claim 11, further comprising:
identifying history information of previous sounding reference signals (SRSs) for compensating the timing offset; and
identifying, based on the compensated timing offset using the previous SRSs, a forgetting factor for updating the reference of the non-coherent maximum likelihood estimator in accordance with a channel profile.

20. The method of claim 19, further comprising:
compensating the timing offset for SRSs stored in an SRS buffer excluding a current SRS; and
storing the current SRS into the SRS buffer.
